(19) United States
(12) Patent Application Publication
(10) Pub. No.: US 2011/0177400 A1
(43) Pub. Date: Jul. 21, 2011

(54) Protected lithium-air cells by oxygen-selective permeable cathode membranes

(76) Inventors: David Chua, Wayne, PA (US); Arthur Driedger, Spring City, PA (US); Benjamin Meyer, Landsdale, PA (US); Michael Morgan, Spring City, PA (US); Mark Salomon, Little Silver, NJ (US)

(21) Appl. No.: 12/657,481

(22) Filed: Jan. 21, 2010

(51) Int. Cl. H01M 4/36

(52) U.S. Cl. 429/405

(57) ABSTRACT

Advanced lithium-air cell with non-aqueous electrolyte solution is provided, having higher energy density over the prior art cells, due to protective oxygen selective permeable membrane placed over the cathode outer surface. Said membrane protects the cell from moisture and evaporation of said electrolyte, which substantially minimizes parasitic losses of lithium and increases the cell efficiency and safety.

### BACKGROUND OF THE INVENTION

1. Field of Invention

This invention pertains mostly to lithium-air cells and batteries comprising lithium-metal anode, electrically non-conductive porous separator and electrically conductive porous carbon cathode, all activated by ionically conductive, non-aqueous liquid electrolyte; and sealed in a moisture-proof enclosure, which enclosure includes an oxygen-selective permeable membrane over the cathode outer surface. Both electrodes have metal current collectors with terminals exiting the sealed enclosure. Other metal anodes are also useable in this cell structure.

2. Description of the Prior Art

Lithium-air semi-fuel cells, also referred to as lithium-air batteries, are basically composed of a metallic lithium anode and an air (O₂) fuel cell type cathode. The air electrode serves to provide an interface where O₂ from air is catalytically reduced on the active components of a porous cathode, which is commonly carbon with or without a catalyst to enhance the rate of O₂ reduction. To enhance the electrochemical reduction of oxygen in the cathode, one approach is to employ an aprotic solvent in which the solubility and diffusibility of gaseous oxygen is very large (as described in see the publications of Read, and Kowalczk et al.). However, many of these aprotic solvents have high vapor pressures and can rapidly diffuse out of the cell, resulting in rapid cell failure. By utilizing an aprotic solvent such as an organic-based, or ionic liquid-based electrolyte solution, the products of the cell reactions are insoluble Li₂O and Li₂O₂. For the lithium-air semi-fuel cell, the overall (mixed) cell reactions in organic electrolyte solutions are:

2Li+½O₂→Li₂O

2Li+O₂Li₂O₂

Because both Li₂O and Li₂O₂ are not soluble in these aprotic electrolyte solutions, both oxides will precipitate in pores of the porous carbon-based cathode which blocks further O₂ intake, and thus ends, cell life. Even with this limitation, lithium-air semi-fuel cells still represent a major advance since the practical achievable specific capacities and specific energies for non-aqueous lithium-air cells are extremely higher than those achievable by lithium-ion batteries and other metal-air aqueous cells as shown in Table 1.

TABLE 1
Theoretical Specific Energy and Capacity
Comparisons for Selected Systems

| | | Specific | Specific |
|---|---|---|---|
| Metal-Air and Li-Ion Systems | OCV | Energy | Capacity |
| (aprotic or aqueous electrolyte solution) | (V) | (Wh/kg) | (mAh/g) |
| 2Li + ½O₂ → Li₂O (aprotic) | 2.913 | 11,248* | 3,862 |
| Li + ½O₂ → ½Li₂O₂ (aprotic) | 2.959 | 11,425* | 3,862 |
| 2Li + ½O₂ + H₂SO₄ [symbol] Li₂SO₄ + H₂O | 4.274 | 1,091* | 255 |
| (aq) | | | |
| 2Li + ½O₂ + 2HCl [symbol] 2LiCl + H₂O | 4.274 | 3,142* | 366 |
| (aq) | | | |
| 2Li + ½O₂ + H₂O [symbol] 2LiOH (aq) | 3.446 | 5,789* | 1,681 |
| Al + 0.75O₂ + 1.5H₂O → Al(OH)₃ (aq) | 2.701 | 4,021* | 1489 |
| Zn + ½O₂ → ZnO (aq) | 1.650 | 1,353* | 820 |
| x6C + LiCoO₂ [symbol] xLiC₆ + Li₁₋ₓCoO₂ | ~4.2 | 420** | 140 |
| (aprotic) | | | |

*The molecular mass of O₂ is not included in these calculations because O₂ is freely available from the atmosphere and therefore does not have to be stored in the battery or cell.
**Based on x = 0.5 in Li₁₋ₓCoO₂.

The major problems of the prior art lithium-air cells and batteries are:
1. The ingress of atmospheric water through the air cathode into the aprotic electrolyte solution which is a significant safety hazard, due to the reaction of water with metallic lithium and lithium salt, which is also causing parasitic capacity loss of lithium of the anode, resulting in much shorter discharge time
2. Evaporation of solvent components of the aprotic electrolyte solution through the porous carbon-based cathode, resulting in decreasing ionic conductivity and eventual cell shutdown when most or all solvents have been lost due to evaporation through the cathode into the atmosphere.

To address these problems, others have proposed to protect the lithium anode by a sealed, ion conductive ceramic glass layer, such as described in U.S. patent of Visco U.S. Pat. No. 7,282,295. However, this ceramic is very brittle and size limited. Also, it adds weight and cost, and does not prevent evaporation of the liquid electrolyte from the cathode, and increases cell resistance. Abraham in U.S. Pat. No. 5,510,209 proposes plastic adhesive tape covering the cathode before cell use. However, during the cell use, the water ingress causes the damage and low efficiency described above. The instant invention provides a solution of these problems by having the outer surface of the carbon-based air cathode and thus the whole cell protected by an inert flexible membrane, gel or liquid, which is specific for oxygen permeability, while simultaneously preventing permeation of water vapor and organic solvents through these protective membranes, gels and liquids.

### SUMMARY OF THE INVENTION

Now it has been found, that substantially longer operational time, efficiency and safety of lithium-air cells and batteries with non-aqueous electrolytes over the prior art cells can be accomplished by protection of cathode outer surface with various oxygen-selective permeable membranes. The present invention pertains to several new technologies developed to extend the operational time and safety of lithium-air cell or battery which utilize electrolyte solutions based on aprotic solvents. These technologies also increase energy density of the cells, due to increased efficiency. The invention can be applied to any type of lithium-air cell, including the cells in which the metallic lithium anode is protected by a glass-ceramic membrane, or a lithium-air cell in which metallic lithium is separated from the cathode by a polymer gel or a porous inert micro-porous membrane containing an aprotic electrolyte solution. Loss of aprotic solvent components from the electrolyte solution and water ingress for both types of lithium-air cells is prevented by applying a protective layer to the outer surface of the carbon-based cathode. By “outer surface” of the air electrode, is meant, the surface facing the atmosphere. The basic components used for this invention are those capable of permitting entry of large quantities of oxygen into the cathode from the atmosphere (about 21% by volume), often selectively over nitrogen, which is the major component of air (about 78%). Other desirable properties of these oxygen-selective permeable membranes include their resistance to dissolution in water and/or polar aprotic solvents, which are the components of electrolyte solutions for use in the lithium-air cells of this invention. Examples of these membranes include layers of perfluorocarbons (PFCs), polysiloxanes (PSOs), fluorinated polysiloxanes (FPSOs), perfluorinated polyethers, copolymers of alkyl methacrylates with PSOs and FPSOs. It is apparent that similar protection can be accomplished by utilizing other oxygen selective components, such as described by R. Battino in several publications, for example.

For the purpose of the lithium-air cells of this invention, the oxygen selective components described above can be directly applied in liquid form to the carbon-based cathode or, preferably, applied to the outer surface of the cathode in gel form, supported by a porous inert polymer such as a porous Teflon membrane or micro-porous poly-alkyl membrane (e.g. polyethylene (PE), polypropylene (PP) and blends of PE and PP), or directly applied to the outer surface of the air electrode as a silicone rubber-based thin film. The silicon type membranes can by formed by cross-linking PSOs and FPSOs either by thermal treatment with an appropriate catalyst or by ultra-violate (UV) cross-linking with an appropriate catalyst. The membranes may be also sealed to the hermetic enclosure of the cell, around the cathode edges. Due to the flexibility of these materials absorbed into or coated onto the outer surface of the carbon-based cathode, the lithium-air cells of this invention will also exhibit high flexibility, thus permitting various designs or configurations in manufacturing, e.g. prismatic and cylindrical constructions. These and other features of lithium-air cells of this invention are described below.

The principal object of this invention is to provide higher energy density lithium-air cell over the prior art cells, due to its protection of lithium and aprotic electrolytes and lithium anodes from water.

Another object of this invention is to provide more efficient and safer lithium-air cell. Other objects and advantages of the invention will be apparent from the description and claims.

### BRIEF DESCRIPTION OF THE DRAWINGS

The nature and characteristic features of the invention will be more readily understood from the following description taken in connection with accompanying drawing, in which:

FIG. 1 illustrates schematic, sectional side view of lithium-air cell of this invention, showing:

The metallic lithium anode pressed onto a metal current tab of a non-amalgam forming metal such as Ni or Cu;

The lithium anode in contact with an aprotic organic or ionic liquid based electrolyte solution embedded in an inert porous inert host, referred to as a lithium-compatible Li⁺-conductive electrolyte;

The porous carbon-based cathode where atmospheric oxygen is electrochemically reduced;

The oxygen selective membrane, gel or liquid covering the outer surface of the cathode prevents components of the internal aprotic electrolyte solution from evaporating into the atmosphere and atmospheric water vapor from entering the cell; and

the moisture-proof housing enclosing the cell.

FIG. 2 is showing discharge curves of lithium-air cells with PFC gels coated on the outer surface of the cathode.

FIG. 3 is showing discharge curves of lithium-air cells with and without a liquid polysiloxane coated onto a Porex membrane and pressed onto the cathode side facing the atmosphere.

FIG. 4 is showing discharge curves of lithium-air cells with and without a cross-lined polysiloxane coated onto a Porex membrane and pressed onto the cathode side facing the atmosphere.

FIG. 5 is showing discharge curves of lithium-air cells with and without a cross-lined polysiloxane coated onto a Porex membrane and laminated to the cathode. The cross-linked silicone rubber is composed of the polysiloxanes FMS123 and FMV4031.

FIG. 6 is showing discharge curves of lithium-air cells with and without the liquid perfluorinated polyether Krytox 1506 coated on the surface of Porex and pressed onto the cathode side facing the atmosphere.

FIG. 7 is showing discharge curves of lithium-air cells with a UV-cured silicone rubber membrane applied to the surface of the cathode directly facing the atmosphere.

It should, of course, be understood that the description and the drawings herein are merely illustrative, and it will be apparent that various modifications, combinations and changes can be made of the structures and the systems disclosed without departing from the spirit of the invention and from the scope of the appended claims.

### DETAILED DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Lithium-air cell usually comprises lithium-metal anode foil or sheet, electrically insulated porous separator and porous carbon cathode sheet or plate, all saturated with ion conductive, non-aqueous electrolyte, and enclosed in a housing having an opening(s) for air access to the cathode. The lithium anode may be also protected by a sealed around ceramic, ion-conductive sheet with a non-aqueous electrolyte between the ceramic and the anode, such as described by Visco in U.S. Pat. No. 4,282,295, which is incorporated herein by reference.

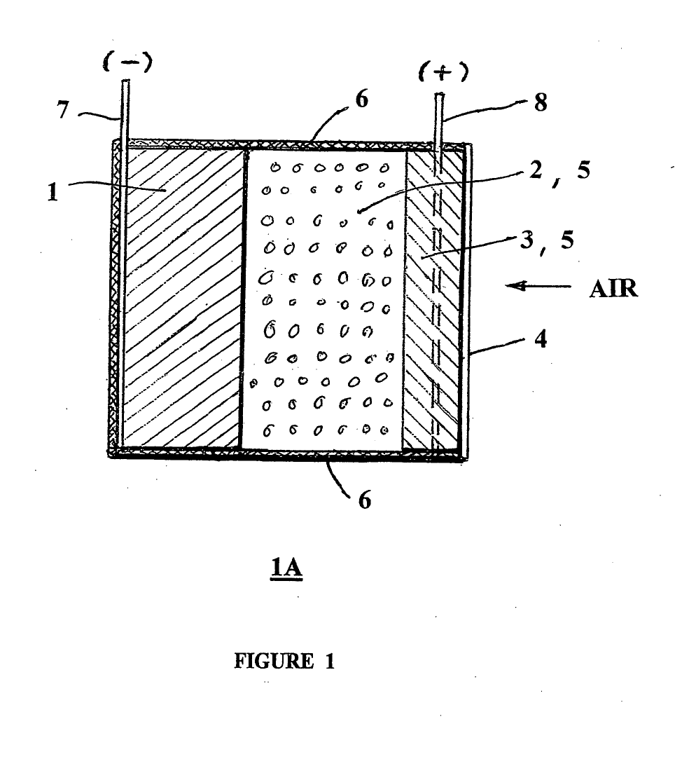

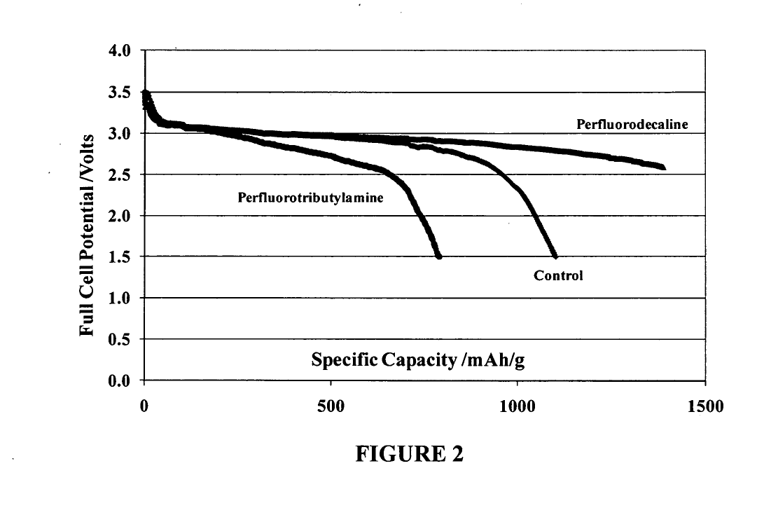

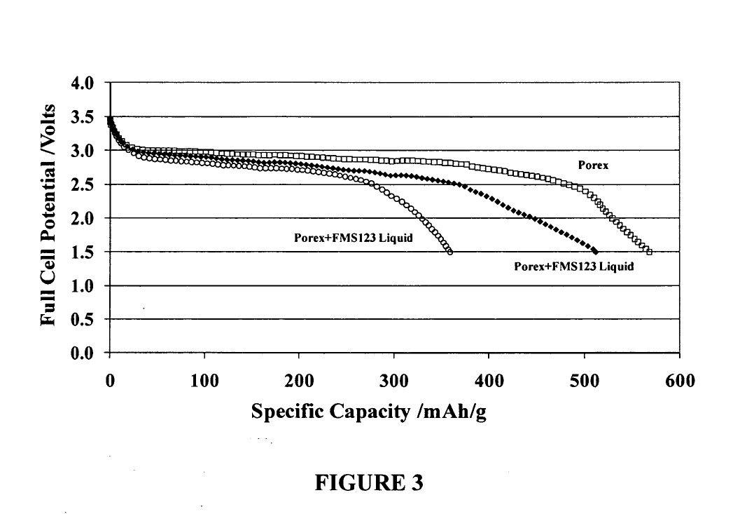

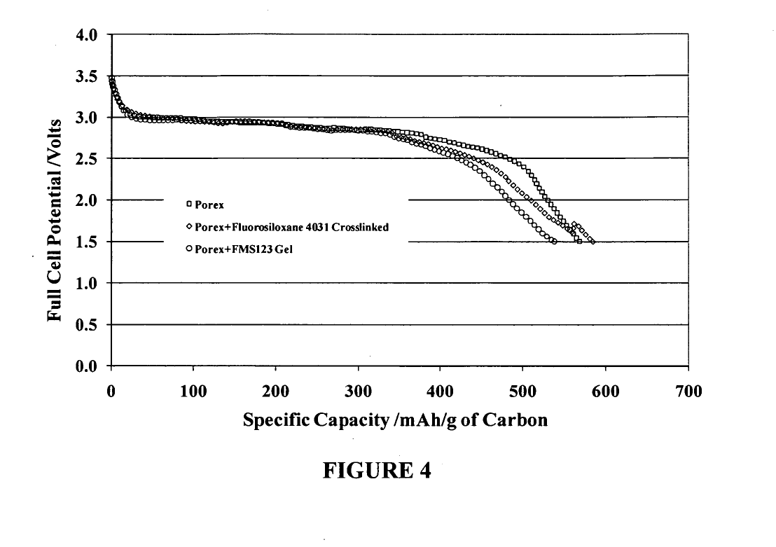

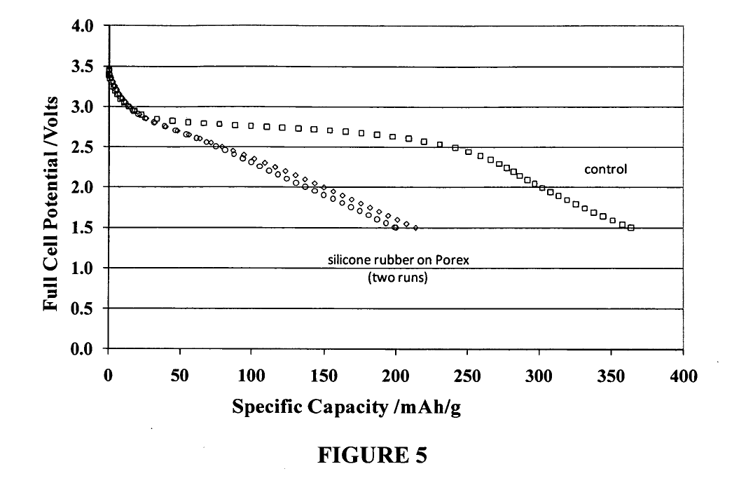

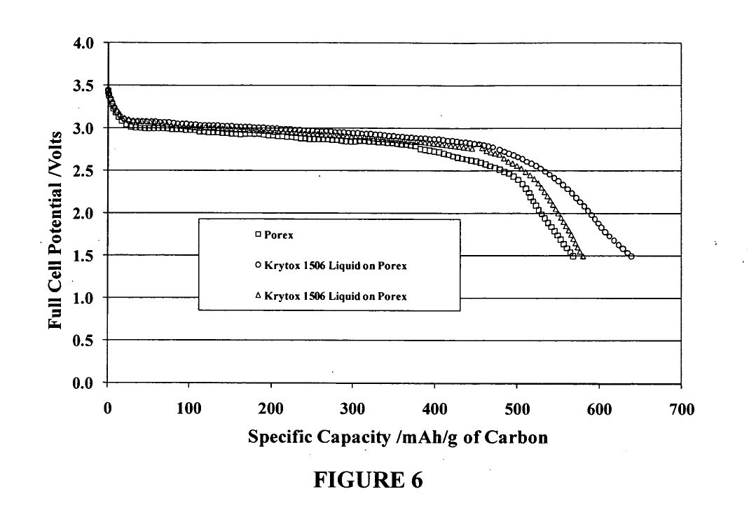

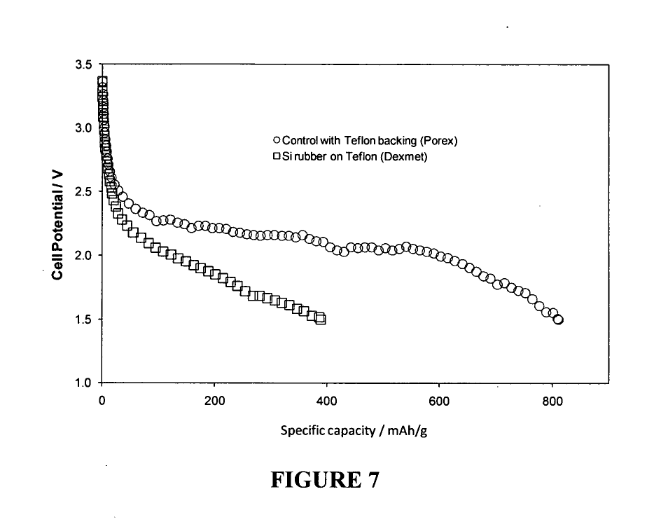

Referring now in more detail and particularly to FIG. 1, which is one embodiment of the invention, showing the sectional side view of the lithium-air cell 1A, which comprises:

lithium anode 1, porous separator 2, porous carbon cathode 3, oxygen-selective permeable membrane 4, lithium-ion conductive, non-aqueous electrolyte 5, anode metal current collector 7, and porous metal cathode current collector 8, both exiting from cell housing 6.

The instant invention pertains to several new technologies developed to extend the operational time and safety of a lithium-air cell or battery, which utilize electrolyte solutions based on aprotic solvents. This technology also increases energy density of the cells, due to increased efficiency. The invention can be applied to any type of lithium-air cell, including the cells in which the metallic lithium anode is protected by a glass-ceramic membrane, or lithium-air cells in which metallic lithium is separated from the cathode by a polymer gel or a porous, inert micro-porous membrane containing a non-aqueous electrolyte solution. Loss of aprotic solvents from the electrolyte solution and water ingress for both types of lithium-air cells is prevented by applying a protective layer to the outer surface of the carbon-based cathode. By outer surface of the air electrode, is meant, the surface facing the atmosphere. The membrane layers 4 used for this invention are those capable of permitting entry of large quantities of oxygen into the cathode from the atmosphere (about 21% by volume), often selectively over nitrogen which is the major component of air (about 78% by volume). Other desirable properties of these oxygen-selective permeable membranes include their resistance to dissolution in water and polar aprotic solvents which are the components of electrolyte solutions for use in the lithium-air cells of this invention.

When the cell of the invention is connected to an electrical load, lithium ions flow from the anode 1 through the separator 2 to the cathode 3 oxygen, providing electric current. For the purpose of the lithium-air cells of this invention, the oxygen selective membranes described above can be directly applied in liquid form to the carbon-based cathode 3, or preferably, applied to the outer surface of the cathode in gel form, supported by a porous inert carrier, such as a porous Teflon membrane or a micro-porous polyalkyl membrane (e.g. polyethylene (PE), polypropylene (PP) and blends of PE and PP), or directly applied to the outer surface of the air electrode 3 as a silicone rubber-based thin film 4. The silicon type membranes can be formed by cross-linking PSOs and FPSOs either by thermal treatment with an appropriate catalyst or by ultra-violate (UV) cross-linking with an appropriate catalyst. The membranes may be also hermetically sealed to the hermetic enclosure of the cells, around the cathode edges.

Due to the flexibility of these materials absorbed into or coated onto the outer surface of the carbon-based cathode, the lithium-air cells of this invention will also exhibit high flexibility, thus permitting various designs or configurations in manufacturing, e.g. prismatic and cylindrical constructions. The membranes 4 also block ingress of water into the cell. There are many oxygen selective materials, which exhibit these properties, and examples of some preferred materials are given below.
Perfluoroflorocarbons (PFCs). Examples are as perfluorodecalin and perfluorotributylamine (commercially available from Aldrich-Sigma Chemicals). An example of fabricating gels based on PFCs is given in U.S. Pat. No. 4,879,062.
Polysiloxanes such as polyfluorosiloxane such as poly(3,3,3-trifluoropropylmethyl) siloxane (Gelest's product FMS123), and vinyl terminated trifluoropropylmethylsiloxane (Gelests's product FMV-4031). These polysiloxanes can be cured (cross-linked or vulcanized) by UV or thermally using a catalyst such as 2,4-dichlorobenzoyl peroxide which is available from Gelest.
Other silicones such as Semicosil 964 UV which is a mixture of N,N′,N″-tricyclohexyl-1-methylsilantriamine and 2-hydroxy-2-methyl-1-pheny-propane-1-one and cross-linked with UV. Semicosil 964 UV is a commercial product of Wacker Chemie AG. Other amino and amine functional silicones are available from Gelest.
Perfluorinated polyethers such as F—(CF(CF₃)—CF₂—O)ₙ—CF₂CF₃ (e.g. Dupont's Krytox 1506).
Alkylmethacrylates such as methyl methaylacrylate, hexamethylene diacrylate commonly used as copolymers with polysiloxanes and silicones (commercially available from Contamac Ltd).

Application of the above building-block materials to the outer surface of the air cathode can be accomplished by direct application of a liquid or gel to the cathode surface, forming a film on the outer electrode surface by curing (i.e. cross-linking or vulcanization) to yield a silicon rubber type of protective layer, or incorporation of any of the above in a host matrix to enhance mechanical support. Examples of host matrix materials described in this invention are the following;
Polytetrafluoroethylene (PTFE) 4.5 mil (114.3 μm) thick porous membrane from Porex.
Polytetrafluoroethylene (PTFE) 2 mil (50.8 μm) thick porous membrane 2TF5-6/0 from Dexmet.
Polyalkyl micro-porous membranes such as polyethylene (PE), polypropylene (PP) and composites of PE and PP which are typically 0.98 mil (25 μm) thick and available from Celgard and other manufacturers.
Polyvinylidene Fluoride (PVDF) such as Kynar PVDF-2801 can be used as a host matrix to produce gels based on the building-block materials listed above.

There are no limitations on the type or air cathode which can be used in this invention. Commercial air cathodes from ETEK or Electric Fuel Ltd can be used as well as custom designed air cathodes based on carbons well known to practitioners in the art of fabricating and manufacturing fuel cell and lithium-air cell cathodes. Carbons such as Super P, Vulcan XC-72, Black Pearls 2000 and Ketjen Blacks 300 and 600 are preferred examples.

### EXAMPLES

The following examples provide details of lithium-air cell performance at room temperature based on the principles of this invention. These examples are provided to clearly illustrate the principles of this invention and are not intended to be limiting.

### Example 1

### A Lithium-Air Cell with a Perfluorodecaline Gel Protected Cathode

A lithium-air cell as shown in FIG. 1 was built using an Electric Fuel EP4 cathode. The thickness of the cathode was 0.5 mm, and the exposed outer surface area was 1.27 cm². The electrolyte solution used was 1.0 mol dm⁻³ LiBF₄ in a 1:1 mixture by volume of propylene carbonate (PC) and dimethyl carbonate (DMC). A perfluorodecaline water-immiscible gel was applied to the outer surface of the cathode; thickness of the gel was 0.22″ (558.8 μm). The gel was prepared by placing 18 cm³ of a 5% W/W Pluronic F68 surfactant into a 25 cm³ centrifuge tube. Then adding 4 grams of the perfluorodecaline and the mixture sonicated using an ultrasonic probe. The probe was energized at 40% of full power for 1 minute. The tube was then transferred to a centrifuge where it is centrifuged at 4000 rpm for 2 hours. The end product is a white solid at the bottom of the centrifuge tube which is the gel, as shown in the U.S. Pat. No. 4,879,062. The cell was placed in a sealed plastic bag filled with oxygen and discharged at a current density of 0.1 mA/cm². The discharge behavior of this cell is shown in FIG. 2, which is another embodiment of the invention.

### Example 2

### A Lithium-Air Cell with a Perfluorotributylamine Gel Protected Cathode

A lithium-air cell as shown in FIG. 1 was built using an Electric Fuel EP4 cathode. The thickness of the cathode was 0.5 mm, and the exposed surface are was 1.27 cm². The electrolyte solution used was 1.0 mol dm⁻³ LiBF₄ in a 1:1 mixture by volume of propylene carbonate (PC) and dimethyl carbonate (DMC). A perfluorotributylamine water-immiscible gel was applied to the outer surface of the cathode; thickness of gel was 0.006″ (152.4 μm). The gel was prepared by placing 18 cm³ of a 5% W/W Pluronic F68 surfactant into a 25 cm³ centrifuge tube. Then adding 4 grams of the perfluorotributylamine and the mixture sonicated using an ultrasonic probe. The probe was energized at 40% of full power for 1 minute. The tube was then transferred to a centrifuge where it is centrifuged at 4000 rpm for 2 hours. The end product is a white solid at the bottom of the centrifuge tube which is the gel, as shown in U.S. Pat. No. 4,879,062. The cell was placed in a sealed plastic bag filled with oxygen and discharged at a current density of 0.1 mA/cm². The discharge behavior of this cell is shown also in FIG. 2, which is another embodiment of the invention.

### Example 3

### A Lithium-Air Cell with a Liquid Polysiloxane Applied to the Protective Cathode Membrane

A lithium-air cell as shown in FIG. 1 was built using an Electric Fuel EP4 cathode. The thickness of the cathode was 0.5 mm, and the exposed outer surface area was 10.0 cm². The electrolyte solution used was 1.0 mol dm⁻³ LiBF₄ in a 1:1 mixture by volume of propylene carbonate (PC) and dimethyl carbonate (DMC). Liquid polysiloxane FMS-123 from Gelest was absorbed into a Porex membrane. The Porex membrane was then pressed onto the outer surface of the cathode, discharge behavior of two of these cells is shown in FIG. 3, which is another embodiment of the invention.

### Example 4

### A Lithium-Air Cell with a Silicone Rubber Applied to the Outer Surface of the Cathode

A lithium-air cell as shown in FIG. 1 was built using an Electric Fuel EP4 cathode. The thickness of the cathode was 0.5 mm, and the exposed outer surface area was 10.0 cm². The electrolyte solution used was 1.0 mol dm⁻³ LiBF₄ in a 1:1 mixture by volume of propylene carbonate (PC) and dimethyl carbonate (DMC). The outer surface of the cathode was covered with a thermally cured silicone rubber prepared as follows: Vinyl terminated fluorosiloxane FMV-4031 from Gelest was used to produce a fluorosiloxane film that was thermally cross-linked similar to the method described in the U.S. Pat. No. 4,317,616, but at a much lower temperature. Fifteen grams of FMV-4031 and 1 gram of 50% w/w 2,4-dichlorobenzoyl peroxide catalyst with silicone oil were mixed in a 250 cm³ beaker and 25 cm³ of methyl ethyl ketone (MEK) added to dissolve the fluorosiloxane and catalyst. This mixture was applied to a Porex membrane, and then cured in an oven at 285° C. for 30 minutes. The thickness of Porex membrane is 4.5 mils (114.3 μm) and the silicone rubber coating on the Porex was 1.5-2.0 mils (38.1 to 50.8 μm). The cell was placed in a sealed plastic bag filled with oxygen and discharged at a current density of 0.1 mA/cm². The discharge behavior of this cell is shown in FIG. 4, which is another embodiment of the invention.

### Example 5

### A Lithium-Air Cell with a Silicone Rubber Applied to the Outer Surface of the Cathode

A lithium-air cell as shown in FIG. 1 was built using an Electric Fuel EP4 cathode. The thickness of the cathode was 0.5 mm, and the exposed outer surface area was 10.0 cm². The electrolyte solution used was 1.0 mol dm⁻³ LiBF₄ in a 1:1 mixture by volume of propylene carbonate (PC) and dimethyl carbonate (DMC). The outer surface of the cathode was covered with a thermally cured silicone rubber prepared as follows. A mixture of fluorosiloxane film that was thermally cross-linked similar to the method described in U.S. Pat. No. 4,317,616, but at a much lower temperature. A mixture of 1.9 g (1% on a mole basis) FMV-4031, 13.1 g FMS-123, 1 g of 50% w/w 2,4-dischlorobenzoyl peroxide with silicone oil, were dissolved in 25 cm³ of methyl ethyl ketone (MEK). This solution was applied to a Porex membrane, and then cured in an oven at 285° C. for 30 minutes. The thickness of the Porex membrane is 4.5 mils (114.3 μm) and the silicone rubber coating on the Porex was 3.0 mils (76.2 μm). The cell was placed in a sealed plastic bag filled with oxygen and discharged at a current density of 0.1 mA/cm². The discharge behavior of this cell is shown in FIG. 5, which is another embodiment of the invention.

### Example 6

### A Lithium-Air Cell with a Polysiloxane Gel Applied to the Outer Surface of the Cathode

A lithium-air cell as shown in FIG. 1 was built using an Electric Fuel EP4 cathode. The thickness of the cathode was 0.5 mm, and the exposed outer surface area was 10.0 cm². The electrolyte solution used was 1.0 mol dm⁻³ LiBF₄ in a 1:1 mixture by volume of propylene carbonate (PC) and dimethyl carbonate (DMC).

A gel based PVDF using Gelest's polysiloxane FMS-123 was prepared as follows:

A solution of 6 g of PVDF-2801 was dissolved in 50 cm³ of acetone to which 10 g of FMS-123 was added. The solution was stirred vigorously and then immediately cast onto a glass plate. When the acetone evaporated, the resulting gel was peeled off and then pressed onto the outer surface of the air electrode. The thickness of the FMS-123 gel was 3 to 4 mils (76.2 to 101.6 μm). The cell was placed in a sealed plastic bag filled with oxygen and discharged at a current density of 0.1 mA/cm². The discharge behavior of this cell is shown in FIG. 4, which is another embodiment of the invention.

### Example 7

### A Lithium-Air Cell with a Liquid Perfluorinated Polyether Applied to the Protective Cathode Membrane

A lithium-air cell as shown in FIG. 1 was built using an Electric Fuel EP4 cathode. The thickness of the cathode was 0.5 mm, and the exposed outer surface area was 10.0 cm². The electrolyte solution used was 1.0 mol dm⁻³ LiBF₄ in a 1:1 mixture by volume of propylene carbonate (PC) and dimethyl carbonate (DMC).

Ten grams of Dupont's liquid perfluorinated polyether Krytox 1506 with a molecular weight of 2400 g/mole was absorbed into a Porex membrane. The Porex membrane was then pressed onto the outer surface of the cathode, and the cell sealed in a plastic bag filled with oxygen and discharged at 0.1 mA/cm². The discharge behavior of two of these cells is shown in FIG. 6, which is another embodiment of the invention.

### Example 8

### A Lithium-Air Cell with a Silicone Rubber Applied to the Outer Surface of the Cathode

A lithium-air cell as shown in FIG. 1 was built using an air cathode based on Ketjen Black 600 carbon. The cathode was prepared in a 3-step process as follows:

Step 1 involves the preparation of a powder of the basic components of the cathode 200 g of methanol were placed in a 500 cm³ beaker. To this was added 3 g of wetting and dispersing additive BYK-P 104 (unsaturated polycarboxylic acid polymer). The mixture was thoroughly mixed using a turbine blade mixer followed by the addition of 10 g of Ketjen Black 600 powder. This composite was mixed for approximately 5 minutes after which was added 4.2 g of an aqueous Teflon dispersion TE-3859 containing 2.5 g of Teflon followed by high speed stirring at 2000 rpm for approximately 30 seconds. The resulting paste was dried at 250° C. followed by grinding in a coffee grinder to produce a fine powder. The composition of the resulting powder was 79.1 mass % Ketjen Black, 19.8% Teflon and 1.1% BYK-P 104.

Step 2 in the process involved mixing 1 gram of the above powder with 6 g of mineral spirits followed by kneading into dough ball. Portions of the dough ball were molded into square pads and the sections of the material were separated into workable balls and molded into square pads which, after calendering had dimensions of 4.5″ (11.2 cm), width, 6″ (15.2 cm) length and around 0.004″ (101.6 μm) thick.

Step 3 in the process involved high temperature pressing of the above pads onto a nickel grid. The pad was placed onto a nickel grid (3Ni-125A-6″) and placed in a press at a temperature of 350° F. (177° C.) and 20,000 lbs for 20 to 30 seconds. The laminated pad and grid was removed from the press and calendared immediately to 4.5 to 4.6 mils (114.3 to 116.8 μm) to produce the finished cathode.

To build lithium-air cells such as shown in FIG. 1, the above finished cathodes were used. The thickness of the cathode was 4.5 mils (114.3 μm), and the exposed outer surface area was 10.0 cm². The electrolyte solution used was 1.0 mol dm⁻³LiBF₄ in a 1:1 mixture by volume of propylene carbonate (PC) and dimethyl carbonate (DMC). The outer surface of the cathode was covered with an UV cured silicone rubber prepared as follows:

Semicosil silicone 964 UV was coated onto Dexmet's porous Teflon 2TF5-6/0 membrane and placed on a conveyer with a belt speed of 23 feet/minute. As the coated membrane traversed along the conveyer, it was exposed to UV radiation of 70 to 448 mJ/cm² to effect cross-linking. The thickness of the Dexmet membrane is 4.5 mils (114.3 μm) and the UV cured silicone rubber coating on the Dexmet was 2.5 to 3.5 mils (63.5 to 88.9 μm). This coated membrane was pressed onto the outer surface of the cell which was then discharged in air at a current density of 0.2 mA/cm². The discharge behavior of this cell is shown in FIG. 7, which is another embodiment of the invention.

### Comparative Examples

In FIGS. 2-7, some discharge curves are simply labeled “Porex” or “Control”. These curves represent the discharge of a lithium-air cell as shown in FIG. 1 without any protection applied to the outer surface of the cathode. Details are given in the two Comparative Examples below.

### Comparative Example 1

### A Lithium-Air Cell without Protection of the Cathode

A lithium-air cell as shown in FIG. 1 was built using an Electric Fuel EP4 cathode. The outer surface of the cathode was covered with a porous Teflon-based layer as described in the U.S. Pat. No. 5,441,823. The thickness of the cathode was 0.5 mm, and the exposed outer surface are was 10.0 cm². The electrolyte solution used was 1.0 mol dm⁻³LiBF₄ in a 1:1 mixture by volume of propylene carbonate (PC) and dimethyl carbonate (DMC). Cells were placed in sealed plastic bags filled with oxygen and discharged at a current density of 0.1 mA/cm². The discharge behavior of these unprotected cells is shown in FIGS. 2, 3, 4, 5 and 6.

### Comparative Example 2

### A Lithium-Air Cell without Protection of the Cathode

A lithium-air cell as shown in FIG. 1 was built using an air cathode based on Ketjen Black 600 carbon. The cathode was prepared by the process described in Example 8 above. The thickness of the cathode was 4.6 mils (116.8 μm) and the exposed outer surface area was 10.0 cm². The electrolyte solution used 1.0 mol dm⁻³LiBF₄ in a 1:1 mixture by volume of propylene carbonate (PC) and dimethyl carbonate (DMC). The outer surface of the cathode was covered with a Porex membrane and discharged in air at 0.2 mA/cm² as shown in FIG. 7.

The oxygen permeable membrane materials of this invention are oxygen-specific compounds exhibiting very high oxygen permeabilities, examples of which are given above. There are many alternate ways of implementing processes for protecting the air electrode, and the present invention is not limited to the details herein.

All references cited herein are incorporated by reference for all purposes.

It should of course be understood, that the description and the drawings herein are merely illustrative and it will be apparent, that various modifications and combinations can be made of the structures and the systems disclosed without departing from the spirit of the invention.

We claim:

1. A lithium-air cell, which comprises:
A lithium metal anode with a metal current collector electroconductively attached to said anode;
an electronically conductive porous carbon cathode coated onto a porous metal current collector;
said cathode having inner and outer surface;
an electrically non-conductive porous separator, saturated with lithium-ion conductive non-aqueous electrolyte therebetween and in contact with said anode and with said cathode inner surface;
a moisture-proof, electrically insulating housing, which housing encloses said anode, said cathode and said separator with said electrolyte;
and said housing having an opening facing said cathode outer surface, and said opening is covered by an oxygen-selective permeable, moisture-proof membrane, hermetically sealed to said housing;
and said current collectors are exiting from said housing in hermetically sealed manner, and are electrically insulated from said housing.

2. A lithium-air cell as described in claim 1, in which said anode is additionally protected by a hermetically sealed, ionically conductive moisture-proof ceramic layer, facing said cathode inner surface, and said cell having a lithium-ion conductive non-aqueous liquid electrolyte layer between said anode and said ceramic layer.

3. A lithium-air cell as described in claim 1, in which said oxygen-selective permeable membrane is made of materials selected from the group consisting of perfluorocarbon, polysiloxanes, fluorinated polysiloxanes, perfluorinated polyethers and alkyl methacrylate-based copolymers.

4. A lithium-air cell as described in claim 1, in which said oxygen-selective permeable membrane is a liquid material and is coated onto said cathode outer surface.

5. A lithium-air cell as described in claim 1, in which said oxygen-selective permeable membrane is a liquid material and is coated onto a porous carrier membrane, and both are covering said opening in overlaying relation, and are hermetically sealed to said housing.

6. A lithium-air cell as described in claim 1, in which said oxygen-selective permeable membrane is a gelled material and is coated onto said cathode outer surface.

7. A lithium-air cell as described in claim 1, in which said oxygen-selective permeable membrane is a gelled material and is coated onto a porous carrier membrane and both are covering said opening in overlaying relation, and are hermetically sealed to said housing.

8. A lithium-air cell as described in claim 1, in which said oxygen-selective permeable membrane is across-linked material and is coated onto said cathode outer surface.

9. A lithium-air cell as described in claim 1, in which said oxygen-selective permeable membrane is a cross-linked material and is coated onto a porous carrier membrane and both are covering said opening in a overlaying relation, and are hermetically sealed to said housing.

10. A lithium-air cell as described in claim 1, in which said oxygen-selective permeable membrane materials are silicon rubbers based on polysiloxanes, fluorinated polysiloxanes, alkyl methacrylates and their blends and alloys.

11. A lithium-air cell as described in claims 6 and 7, in which said gelled membranes are flexible.

12. A lithium-air cell as described in claims 8 and 9, in which said cross-linked membranes are flexible.

13. A lithium-air cell as described in claim 1, in which said non-aqueous electrolyte includes a salt selected from the group comprising: LiPF₆, LiBF₄, LiN(SO₂C₂F₅)₃, LiSO₃CF₃, LiClO₄, and their mixtures.

14. A lithium-air cell as described in claim 1, in which said electrolyte solvents are selected from the group comprising propylene carbonate, gamma-butyrolactone, ethylene carbonate, methylethyl carbonate, dimethyl carbonate, dimethoxy ethane, an ionic liquid such as 1-butyl-1-methylpyrrolidinium imide, 1-ethyl-3-methylimidazolium bisperfluoroethylsulfonyl imide, 1-ethyl-3-methylimidazolium bisperfluoroethylsulfonyl imide, and their mixtures.

15. A lithium-air cell as described in claim 1, in which said separator is a polymer electrolyte, in which the host polymer is PVdF, ethymethyl methacrylate, polyacrylonitrile, and their mixtures and alloys.

16. A lithium-air cell as described in claim 1, in which said polymer electrolyte plasticizers are solvents as described in claim 14, and in which said polymer electrolyte salts are as described in claim 13.

17. A cathode for lithium-air cell having inner and outer surface in relation to said cell, which cathode includes an oxygen selective permeable membrane facing said outer surface.

18. A cathode for lithium-air cell as described in claim 17, in which said oxygen selective permeable membrane is made of materials selected from the group consisting of perfluorocarbon, polysiloxanes, fluorinated polysiloxanes, perfluorinated polyethers and alkyl methacrylate based copolymers.
